(19) United States
(12) Patent Application Publication
(10) Pub. No.: US 2016/0009104 A1
(43) Pub. Date: Jan. 14, 2016

(54) RECORDING APPARATUS

(71) Applicant: Seiko Epson Corporation, Tokyo (JP)

(72) Inventors: Kunihiko MATSUHASHI, Matsumoto (JP); Eiji NATORI, Chino (JP); Shinya MOMOSE, Matsumoto (JP)

(21) Appl. No.: 14/796,349

(22) Filed: Jul. 10, 2015

(30) Foreign Application Priority Data
Jul. 11, 2014 (JP) 2014-142943

(51) Int. Cl. B41J 3/407

(52) U.S. Cl. CPC B41J 3/4073

(57) ABSTRACT

A recording apparatus includes an input unit that inputs a standard shape of a medium, a shape recognizing unit that recognizes an actual shape of the medium, a calculating unit that calculates a correction value based on the standard shape and the actual shape, and a recording unit that includes an ejecting unit which ejects liquid to the medium, in which recording conditions are adjusted based on the correction value. According to the recording apparatus having such a configuration, the recording corresponding to the mediums having various shapes can be performed.

### BACKGROUND

1. Technical Field

The present invention relates to a recording apparatus.

2. Related Art

In the related art, a recording apparatus has been used in which a recording is performed by ejecting liquid to a medium. In such a recording apparatus, it is preferable that a distance (so called PG) from an ejecting unit which ejects the liquid to the medium is constant. For example, JP-A-2000-280567 discloses a recording apparatus which is capable of making the PG be constant even when the medium is bent, or the like.

The recording apparatus disclosed in JPA-2000-280567 is capable of making a PG in a sheet type medium be constant. That is, a recording corresponding to a shape of the sheet type medium can be performed.

Meanwhile, recently, the recording is required to be performed on mediums having various shapes such as a stereoscopic shape.

### SUMMARY

An advantage of some aspects of the invention is that a recording corresponding to mediums having various shapes is performed.

According to a first aspect of the invention, there is provided a recording apparatus including an input unit that inputs a standard shape of a medium, a shape recognizing unit that recognizes an actual shape of the medium, a calculating unit that calculates a correction value based on the standard shape and the actual shape, and a recording unit that includes an ejecting unit which ejects liquid to the medium, in which recording conditions are adjusted based on the correction value.

In the recording apparatus of a second aspect of the invention, according to the first aspect, the shape recognizing unit recognizes the actual shape of the medium when the liquid is ejected to the medium.

In the recording apparatus of a third aspect of the invention, according to the first aspect or the second aspect, an adjustment of the recording conditions may be an adjustment of at least one of ejecting intervals of the liquid, a diameter of liquid droplet of the liquid, an ejecting speed of the liquid, and a landing angle of the liquid with respect to the recording medium.

In the recording apparatus of a fourth aspect of the invention, according to any one of the first aspect to the third aspect, a holding unit that holds the medium may be further included, and the holding unit may hold the medium in such a manner that at least one of a posture and a position of the medium can be changed with respect to the ejecting unit, and the adjustment of the recording conditions may be an adjustment of at least one of the posture and the position of the medium with respect to the ejecting unit in the holding unit.

In the recording apparatus of a fifth aspect of the invention, according to any one of the first aspect to the fourth aspect, a holding unit that holds the medium may be included, and the recording unit may include an ejecting unit moving mechanism which is capable of changing at least one of the posture and the position of the ejecting unit with respect to the holding unit, and the adjustment of the recording conditions may be an adjustment of at least one of the posture and the position of the ejecting unit with respect to the holding unit in the ejecting unit moving mechanism is adjusted.

In the recording apparatus of a sixth aspect of the invention, according to any one of the first aspect to the fifth aspect, the liquid ejected from the ejecting unit may have a electric charge, the recording unit may include an electrode unit which is capable of changing an ejecting direction of the liquid having the electric charge, and the adjustment of the recording conditions may be an adjustment of the ejecting direction of the liquid by the electrode unit.

In the recording apparatus of a seventh aspect of the invention, according to any one of the first aspect to sixth aspect, the medium may have a stereoscopic shape.

According to the invention, the recording corresponding to the mediums having various shapes can be performed.

### BRIEF DESCRIPTION OF THE DRAWINGS

The invention will be described with reference to the accompanying drawings, wherein like numbers reference like elements.

FIG. 1 is a schematic view illustrating a recording apparatus according to Example 1 of the invention.

FIG. 2 is a block diagram illustrating the recording apparatus according to Example 1 of the invention.

FIG. 3 is a schematic view illustrating a main part of a recording apparatus according to Example 2 of the invention.

FIG. 4 is a schematic view illustrating a main part of a recording apparatus according to Example 3 of the invention.

FIGS. 5A and 5B are schematic views illustrating the main part of the recording apparatus according to Example 3 of the invention.

FIGS. 6A and 6B are schematic views illustrating a main part of a recording apparatus according to Example 4 of the invention.

FIGS. 7A to 7C are schematic views illustrating a main part of a recording apparatus according to Example 5 of the invention.

FIGS. 8A and 8B are schematic views illustrating a main part of a recording apparatus according to Example 6 of the invention.

FIGS. 9A and 9B are schematic views illustrating a main part of a recording apparatus according to Example 7 of the invention.

FIG. 10 is a flow chart of an example of a recording method of the invention.

### DESCRIPTION OF EXEMPLARY EMBODIMENTS

### Example 1

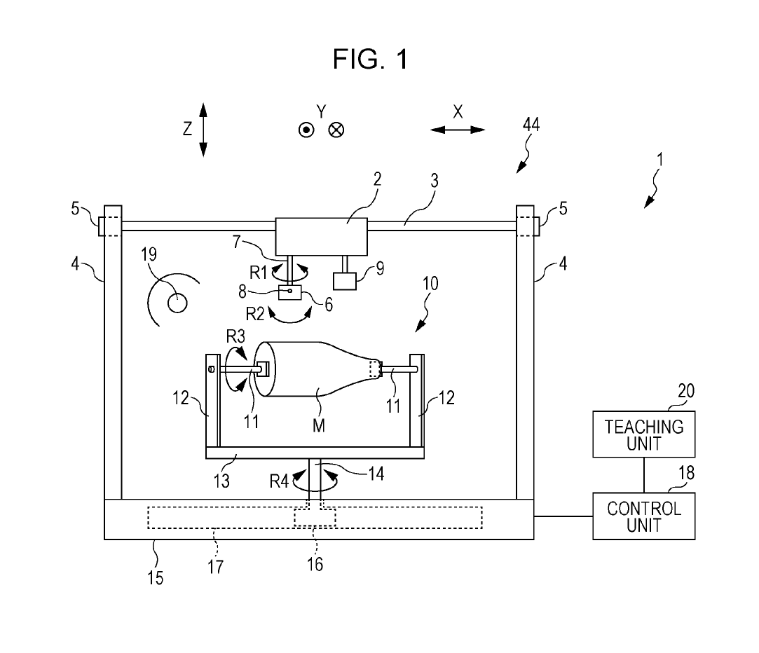

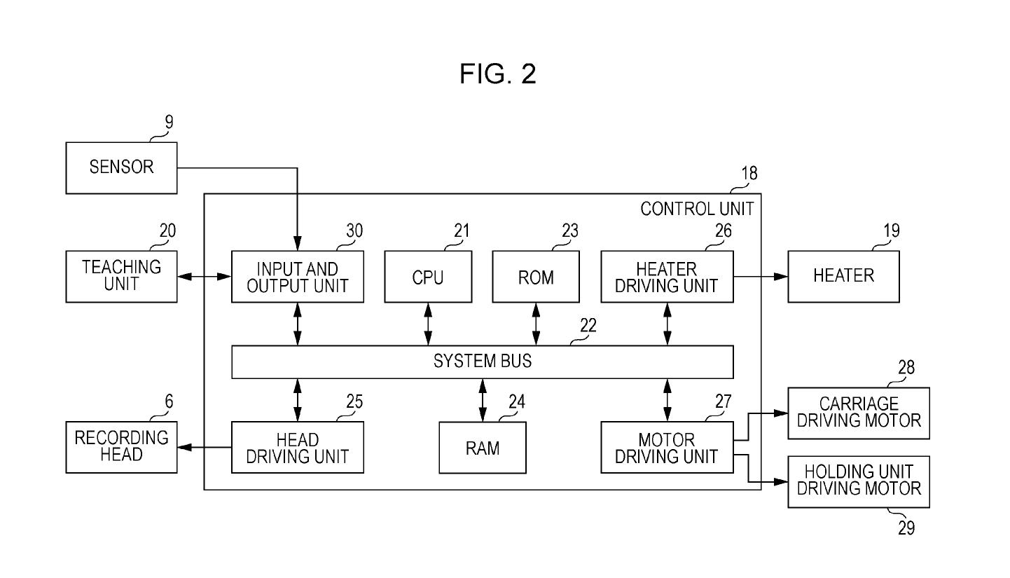

### FIG. 1 to FIG. 2

Hereinafter, a recording apparatus according to Example 1 of the invention will be described in detail with reference to attached drawings.

FIG. 1 is a schematic view of the recording apparatus 1 of the example.

The recording apparatus 1 of the example includes a carriage 2 which includes a recording head 6 as an ejecting unit capable of ejecting ink (liquid) from a nozzle toward a recording medium M (medium) and a sensor 9 as a shape recognizing unit recognizing an actual shape of the recording medium M. Here, the carriage 2 is capable of moving along a carriage supporting shaft 3 in an X direction. In addition, the carriage supporting shaft 3 is supported by a carriage supporting shaft supporting unit 4 including a surface in a direction intersecting with the X direction, and is capable of moving in a Y direction by a carriage supporting shaft moving mechanism 5 provided in the carriage supporting shaft supporting unit 4. The carriage supporting shaft supporting unit 4 is mounted on a base body unit 15 of the recording apparatus 1 in a fixed state. With such a configuration, the carriage 2 is capable of moving in the X direction and Y direction.

Moreover, in FIG. 1, when the recording apparatus 1 of the example is installed on a horizontal surface, the X direction and the Y direction is a horizontal direction, a Z direction is a vertical direction.

In addition, as ink capable of being used in the recording apparatus 1 of the example, there are not only color ink such as black, cyan, magenta, and yellow for forming images on a recording surface the recording medium M, but also ink giving glossiness, ink for forming a base layer, and ink for forming a protection layer which protects the image formed on the recording surface, or the like.

In addition, the recording head 6 is provided to be capable of moving in the Z direction with respect to the carriage 2 through a recording head supporting unit 7, and further, the recording head 6 is configured to be capable of rotating around the recording head supporting unit 7 as a rotation shaft in a rotation direction R1 and to be capable of rotating around a rotation shaft 8 as a fulcrum in a rotation direction R2.

With such a configuration, the recording head 6 of the example is capable of moving in three dimensions of the X direction, the Y direction and the Z direction with respect to the recording medium M, and an angle and a distance from the recording head with respect to the recording surface are capable of being adjusted in accordance with a shape of the recording surface of recording medium M (ink landing surface). In the example, when the recording is performed, an ink ejecting surface of the recording head 6 has a predetermined distance (so called PG) and is substantially in parallel (that is, the ink lands on the recording surface in a substantially vertical direction) with respect to the recording surface. By such a recording, the ink droplets landing on the recording surface has a substantially complete circular shape having small unevenness of a diameter (liquid droplet diameter) so that a high quality recording is capable of being performed.

Here, in the recording apparatus 1 of the example, with such a configuration, a recording unit 44 of the recording apparatus 1 of the example is configured to have the carriage 2, a configuration member of the carriage 2 such as the recording head 6, and a moving mechanism moving the carriage 2 and the recording head 6.

Moreover, a detail of the sensor 9 is not illustrated; however, the sensor 9 of the example is also capable of moving with respect to the recording medium M in the same manner of the recording head 6, and an angle and a distance with respect to the recording medium M are capable of being adjusted in the same manner of the recording head 6. For this reason, the shape of the recording medium M is capable of being recognized with high accuracy.

In addition, the recording apparatus 1 of the example includes a holding unit 10 that holds the recording medium M. The holding unit 10 includes a gripping unit 11 that grips the recording medium M, a stanchion 12 that supports the gripping unit 11, and a rotating plate 13 in which the stanchion 12 is mounted in the fixed state. The gripping unit 11 is capable of rotating with respect to the stanchion 12 in a rotation direction R3, and the rotating plate 13 is capable of rotating around a shaft unit 14 as a rotation shaft in a rotation direction R4. In addition, a cavity unit 17 is provided in a base body unit 15 in the X direction and the Y direction in an extending manner. A distal unit 16 of the shaft unit 14 of the rotating plate 13 moves the cavity unit 17 so that the rotating plate 13 is capable of moving in the X direction and the Y direction. Here, the holding unit 10 of the example includes the gripping unit 11 so as to be capable of reliably gripping the recording medium M.

With such a configuration, the holding unit 10 can make the recording medium M be in various postures and positions with respect to the recording head 6. In addition, the configuration in which the recording medium M can be moved in the Z direction in a held state, or the configuration which further includes a rotation mechanism that includes a rotation shaft in a direction simultaneously intersecting with a length direction of the gripping unit 11 and an extension direction of the shaft unit 14, may be used. By such a configuration, the recording medium M can take more various postures and positions with respect to a lot of the recording heads 6.

In addition, the recording apparatus 1 of the example includes a heater 19 as a drying unit that dries the ink ejected from the recording head 6 to the recording medium M. Moreover, the recording apparatus 1 of the example includes the heater 19 as the drying unit drying the ink; however, the recording apparatus 1 may include other drying units such as a drying unit which dries by blowing air.

In addition, each configuration member in the recording apparatus 1 of the example is controlled by a control unit 18. An instruction unit 20 also serving as an input unit that receives an instruction from a user by inputting the instruction (information) by the user is connected to the control unit 18. As the instruction unit in the example, a personal computer (PC) including a monitor, a keyboard, a mouse, or the like is used; however, it is not limited thereto, and for example, a touch panel, or the like provided in the recording apparatus 1 may be used.

Moreover, as information (recording information) which can be inputted by the user in the instruction unit 20, there are recording image information, a recording density (resolution), a recording speed, usable ink (also ink for base layer or to overcoat), and the like; however, it is not limited thereto, and only a part of these or information other than these may be used.

Next, an electrical configuration in the recording apparatus 1 of the example will be described.

FIG. 2 is a block diagram of the recording apparatus 1 of the example.

A CPU 21 which overall controls the recording apparatus 1 is provided in the control unit 18. Through a system bus 22, the CPU 21 is connected to a ROM 23 that stores various control programs, or the like executed by the CPU 21, and to a RAM 24 capable of temporally storing data.

In addition, the CPU 21 is connected to a head driving unit 25 that drives a recording head 6 through the system bus 22.

In addition, the CPU 21 is connected to a heater driving unit 26 that drives a heater 19 through the system bus 22.

In addition, the CPU 21 is connected to a motor driving unit 27 through the system bus 22.

The motor driving unit 27 is connected to a carriage driving motor 28 as the ejecting unit moving mechanism and to a holding unit driving motor 29 as a holding unit moving mechanism.

Here, the carriage driving motor 28 indicates all motors that move the carriage 2 and a configuration member of the carriage 2, such as a motor moving the carriage 2 in the X direction, a motor moving the carriage supporting shaft 3 in the Y direction, and a motor rotationally moving the recording head 6 in the rotation directions R1 and R2.

In addition, the holding unit driving motor 29 indicates all motors that move the holding unit 10 and a configuration member of the holding unit 10, such as a motor moving the gripping unit 11 in the rotation direction R3, a motor moving the rotating plate 13 in the rotation direction R4, and a motor moving the rotating plate 13 along the cavity unit 17 in the X direction and the Y direction.

Further, the CPU 21 is connected to an input and output unit 30 through the system bus 22. The input and output unit 30 is connected to the sensor 9 and the instruction unit 20.

The recording apparatus 1 of the example can perform recording on the recording medium M which is a deformable stereoscopic shape made of a plastic material having flexibility. A standard shape is set to the recording medium M, and recording is performed on the standard shape recording medium M, such that the recording with high quality is easily performed.

Here, the “standard shape” means an ideal shape of the recording medium M when the recording apparatus 1 performs the recording on the recording medium M, and the shape can be determined arbitrarily, including a shape at the time of manufacturing the recording medium M, an average shape of the recording medium M, a shape at the time of using the recording medium M; and the shape is not particularly limited.

In the recording apparatus 1 of the example, the control unit 18 can calculate a correction value based on the standard shape of the recording medium M and an actual shape recognized by the sensor 9. That is, the control unit 18 also serves as a calculating unit.

Moreover, the recording corresponding to the stereoscopic shape recording medium M is more difficult than a recording corresponding to a sheet type recording medium M; however, according to the recording apparatus 1 of the example, the recording corresponding to stereoscopic shape recording medium M can be performed.

In addition, the user is capable of inputting the standard shape using the instruction unit 20. The inputting of the standard shape can be executed by the user selecting the shape among a plurality of the standard shapes stored in the ROM 23 using a PC as the instruction unit 20, and in addition, can also be executed by the user drawing the standard shape using the PC and transmitting the drawn resultant to the control unit 18. As described above, the user freely selects the standard shape so that a degree of freedom of a selection regarding the standard shape becomes wide.

Accordingly, the recording apparatus 1 of the example performs the recording on the medium by the user inputting the standard shape using the instruction unit 20, calculating the correction value using the control unit 18 corresponding to the actual shape of the recording medium M recognized by the sensor 9, and ejecting the ink from the recording head 6 while adjusting a recording condition based on the correction value.

In addition, the correction value corresponding to various mediums is calculated by assuming various standard shapes. As described above, the invention is configured to adjust the recording condition based on the correction value and to perform the recording corresponding to various shapes mediums.

Moreover, a calculation method of the correction value is not particularly limited. For example, there is a method such as an operation method for suppressing an unevenness of an ink landing position due to a difference of an incidence angle of the ink (landing direction) with respect to the recording surface of recording medium M when the ink is ejected to a curved surface. Specifically, when the recording is performed on the curved surface with a constant frequency and a constant moving speed of the recording head 6, the adjacent ink landing positions are close each other as the incidence angle is close to a right angle. For this reason, there is a calculation method such as increasing the frequency or decreasing the moving speed of the recording head 6, in order for the adjacent ink landing positions to be close each other when the incidence angle is far from a right angle. In addition, since the ink landing position is close to a complete circular shape as the incidence angle is close to a right angle and becomes an ellipse as the incidence angle is far from the right angle, there is also a method for reducing (increasing resolution) a liquid droplet diameter at the time of ejecting the ink to the curved surface in order to suppress a deterioration of an image quality due to the influence.

Here, before performing a recording operation, that is, when the ink is ejected to the recording medium M, the control unit 18 controls the sensor 9 so as to recognize the actual shape of the recording medium M. For this reason, since the correction value is calculated based on the shape of the recording medium M at the time of performing the recording, the recording by corresponding to various shapes of recording medium M can be performed with high accuracy.

In addition, in a adjustment of the recording conditions, ejecting intervals of the ink (ejecting frequency), a diameter of liquid droplet of the ink, an ejecting speed of the ink, a landing angle of the ink with respect to the recording medium M, and the like can be adjusted. Specifically, magnitude or a waveform of applying voltage with respect to the recording head 6, a direction or a position of the recording head 6 with respect to the recording medium M, and the like can be adjusted.

Here, the recording head 6 of the example is a recording head including a piezoelectric element as a recording element. However, a recording head including the heater as the recording element may be used.

In addition, in other adjustment of the recording conditions, the posture and the position of the recording medium M with respect to the recording head 6 by moving the holding unit 10 may be adjusted.

However, it is preferable that an adjustment in which the recording surface of the recording medium M is set substantially horizontal and the recording is performed so that the ink is not moved (dripping) due to an influence of gravity before drying the ink landing on the recording medium M.

Moreover, every part having the same shape in the recording medium M is put together one block, and different recording conditions may be applied in every block.

In addition, the recording apparatus 1 of the example can adjust the shape of the recording medium M to be close to the standard shape using a centrifugal force by rotating the recording medium M with the gripping unit 11 as the rotation shaft in the rotation direction R3 and with the shaft unit 14 as the rotation shaft in the rotation direction R4 in a state in which the recording medium M is reliably gripped by the gripping unit 11. That is, the holding unit 10 also serves as a shape adjusting unit that adjusts the shape of the recording medium M to the standard shape. A deterioration of the quality of the recording image according to unstable state of the shape of the recording medium M which is deformable can be suppressed.

In addition, in other words, since the gripping unit 11 also serves as the shape adjusting unit, the shape adjusting unit is not needed to be separately provided, and therefore, simplification of an apparatus configuration and low costs are realized.

The recording apparatus 1 of the example is configured to be capable of dispensing with a part of the configuration members thereof or to be capable of compensating for a function by other configuration members without using functions of a part of the configuration members.

In other words, the recording apparatus 1 of the example includes a first unit including at least a part of functions for recording and a second unit including other functions different from the functions of the first unit aiming the functions for recording. The first unit and the second unit are operated based on common recording information, and functions of one of the first unit and the second unit can be compensated for by another.

Further, in other words, in the functions of the first unit and the second unit, when functions are insufficient with respect to the functions for recording, at least one of the first unit and the second unit includes substitute functions with respect to the insufficient functions.

With such a configuration, in the recording apparatus 1 of the example, even when one of the first unit and the second unit is malfunctioned, the other unit can compensate for the insufficient functions. In addition, the configuration member executing the functions can be dispensed with for reducing the cost thereof, or the like, and a degree of freedom of combination and a degree of freedom of rearrangement of the unit can increase.

Here, the “unit” means a unit configured to have a plurality of configuration members, in addition to a unit configured to have one integrated configuration member having a plurality of the functions.

Specifically, the recording apparatus 1 of the example includes the instruction unit 20 having an input function for inputting the standard shape of the stereoscopic shape recording medium M, the sensor 9 having a shape recognizing function for recognizing the actual shape of the recording medium M, the control unit 18 having a calculating function for calculating the correction value based on the standard shape and the actual shape, the recording head 6 having an ejecting function for ejecting the ink onto the recording medium M, and the heater 19 having a drying function for drying the ink which is ejected onto the recording medium M.

For example, the sensor 9 can be dispensed with. Accordingly, the recording can be performed in a state in which the sensor 9 is dispensed with. In this case, for example, the accuracy of the standard shape input by the instruction unit 20 increases and the standard shape closer to the actual shape is input so that the shape recognizing function of the sensor 9 can be compensated for. Moreover, information relating to the shape of the recording medium M which is measured in advance may be input as the standard shape. Accuracy is further improved by inputting the information which is measured in advance.

In addition, for example, the heater 19 can be dispensed with. The recording can be performed in a state in which the heater 19 is dispensed with. In this case, for example, the control unit 18 can compensate for the drying function of the heater 19 by controlling the recording in a recording mode in which the diameter of ink ejected from the recording head 6 is small or the recording for a recording mode in which the recording speed is slow so as to make it easy to dry the ink naturally, or the like.

That is, the recording apparatus 1 of the example can dispensed with at least one of the first unit and the second unit, and the other can compensate for the insufficient function generated due to dispensing with the one of units.

Moreover, the recording apparatus 1 of the example can not only make a compensation for a function generated due to dispensing with the configuration members but also a function based on other reasons. For example, in a case in which the incidence angle of the ink with respect to the recording surface of recording medium M is not easy to adjust, the control unit 18 can control so that the recording can be performed in a recording mode in which the diameter of ink ejected from the recording head 6 is small in order to suppress dripping of the liquid. In addition, in other examples, the incidence angle of the ink can be adjusted by changing the moving speed of the recording head 6 instead of controlling the ejecting conditions of the ink. Further, in other examples, the function for controlling the ejecting conditions of the ink can be compensated for by changing a type of ink ejected from the recording head 6 to a type of ink which is easily dried or changing a type of ink forming the base layer so as to make the ink settled easily.

Further, the recording apparatus 1 of the example can further include a third unit having functions corresponding to the insufficient functions when there are the insufficient functions among the above described functions and other functions so as to compensate for the insufficient functions.

Moreover, the recording apparatus 1 of the example can compensate for the above described functions. For this reason, not only compensation for a function generated due to dispensing with the configuration members, but also compensation for the function of the configuration member which does not work well is possible using other configuration members, instead of using the configuration member, when a part of the configuration member does not work well.

In addition, when a new unit is provided by being added, changed, or the like, if the existing units have information such as various setting information, recording information, shape information including the standard shape, and the like, but new unit does not have the information, the existing unit can send the new unit the information required by the new unit. For this reason, new unit can be easily added. That is, each unit mutually recognizes states of the other units, and these units are related to each other. The recording apparatus 1 is set to be in an optimum state in response to a configuration of the units.

### Example 2

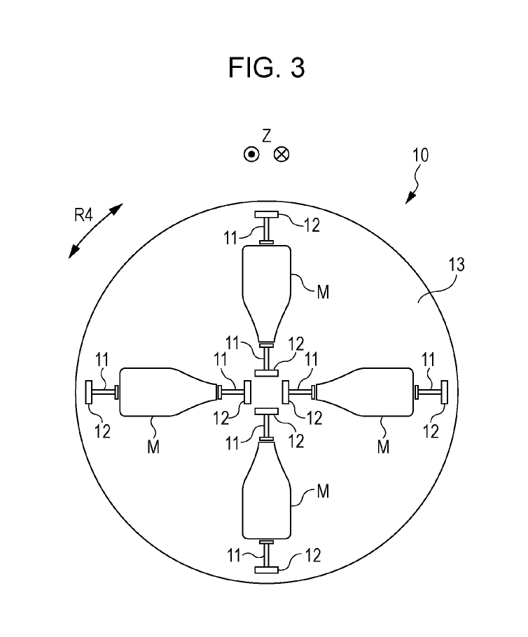

### FIG. 3

Next, the recording apparatus 1 of Example 2 will be described in detail with reference to the attached drawings.

FIG. 3 is a schematic view illustrating the holding unit 10 which is a main part of the recording apparatus 1 of Example 2. Moreover, configuration members which are common to the above example are illustrated by the same numerals as those of the above described configuration members, and a detailed description thereof will be omitted.

Moreover, the recording apparatus 1 of Example 2 has the same configuration as the recording apparatus 1 of the Example 1, except that the holding unit 10 can movably hold a plurality of the recording medium M.

As illustrated in FIG. 3, the recording apparatus 1 of the example is provided with four set positions of the recording medium M (the set positions respectively include the gripping unit 11 and the stanchion 12) on the rotating plate 13. With such a configuration, the recording corresponding to any one of four positions in which the stereoscopic shape recording mediums M are set is performed, and productivity (total recording speed with respect to a plurality of the recording mediums M) is improved.

Moreover, among the recordings with respect to four recording mediums M which are held by the holding unit 10, if a first recording to the recording medium M is terminated, when recording is performed with respect to the recording medium M in a second recording henceforth, the shape recognition of the recording medium M by the sensor 9 is omitted and information relating to the shape recognizing in the recording medium M at the time of the first recording may be used.

### Example 3

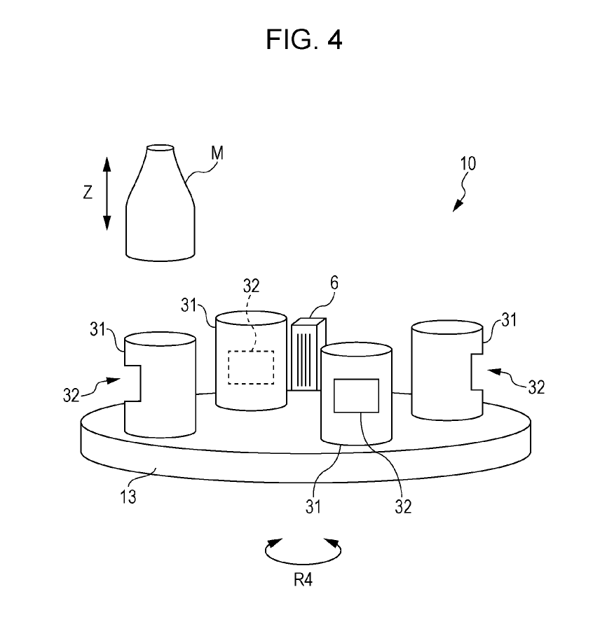

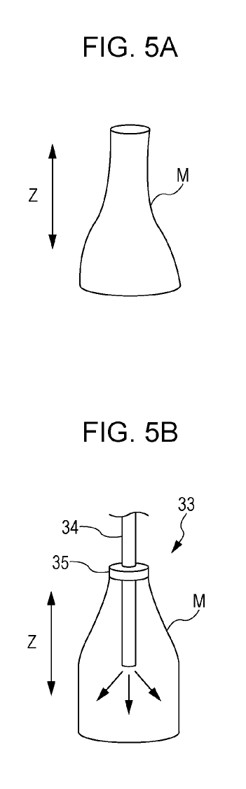

### FIG. 4 to FIG. 5B

Next, the recording apparatus 1 of Example 3 will be described in detail with reference to the attached drawings.

FIG. 4 to FIG. 5B are schematic views illustrating the holding unit 10 which is a main part of the recording apparatus 1 of Example 3. Moreover, configuration members which are common to the above example are illustrated by the same numerals as those of the above described configuration members, and a detailed description thereof will be omitted.

Moreover, the recording apparatus 1 of the example has the same configuration as the recording apparatus 1 of the Examples 1 and 2, except the holding unit 10.

The recording apparatus 1 of the Examples 1 and 2 have a configuration in which the recording medium M is held by being gripped by the gripping unit 11 from a direction intersecting with the Z direction. Meanwhile, in the recording apparatus 1 of the example, as illustrated in FIG. 4, the recording medium M is held by being fitted to a set unit 31 having a cylindrical shape in the Z direction.

In addition, as illustrated in FIG. 4, a concave unit 32 having a rectangle shape is formed in the set unit 31, and recording is performed with respect to the recording medium M which is set in the set unit 31 through the concave unit 32 by disposing the recording head 6 on a position facing the concave unit 32. Since the recording apparatus 1 of the example has such a configuration, a user sets the recording medium M in the set unit 31 so that a part of the recording medium M on which the user wants to print faces the concave unit 32.

In addition, in the holding unit 10 of the example, as illustrated in FIG. 5B, the shape adjusting unit 33 capable of adjusting the shape of the recording medium M by injecting air into the inside of the recording medium M (that is, pressurizing the inside thereof) is provided. The shape adjusting unit 33 includes the cylinder unit 34 and a lid unit 35 and adjusts the shape of the recording medium M by injecting the air into the inside of the recording medium M in a modified shape which is illustrated in FIG. 5A. Moreover, in the holding unit 10 of the example, one shape adjusting unit 33 is provided; however, it is not limited thereto, and a plurality of the shape adjusting units 33 may be respectively provided to correspond to each set unit 31.

Accordingly, the recording apparatus 1 of the example has a configuration in which the shape is adjusted by pressurizing the inside of the recording medium M, but for example, the shape may be adjusted by decompressing the outside of the recording medium M than the inside thereof. That is, the shape of the recording medium M may be adjusted by changing a pressure to at least any one of the inside and outside of the recording medium M. According to the above described configuration, in the recording medium M, or the like used in the examples, the shape of the recording medium M can be adjusted with high accuracy.

### Example 4

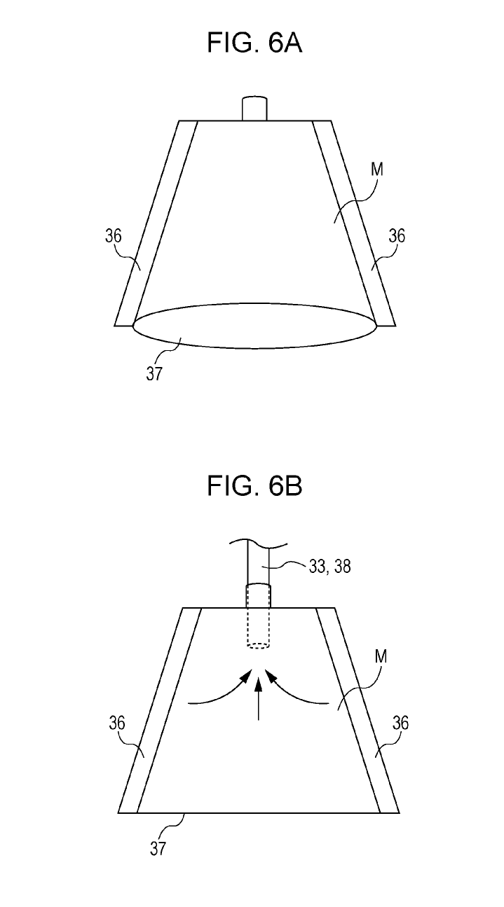

### FIGS. 6A and 6B

Next, the recording apparatus 1 of Example 4 will be described in detail with reference to the attached drawings.

FIG. 6A and FIG. 6B are schematic views illustrating the holding unit 10 which is a main part of the recording apparatus 1 of Example 4. Moreover, configuration members which are common to the above example are illustrated by the same numerals as those of the above described configuration members, and a detailed description thereof will be omitted.

Moreover, the recording apparatus 1 of the example has the same configuration as the recording apparatus 1 of Examples 1, 2, and 3, except the holding unit 10.

The recording apparatus 1 of Example 3 has a configuration in which the shape of the recording medium M is adjusted by injecting the air into the inside of the recording medium M. Meanwhile, the recording apparatus 1 of the example has a configuration in which the shape of the recording medium M is adjusted by decompressing the inside of the recording medium M.

The shape of the recording medium M varies, and for example, is in a pouch shape as illustrated in FIG. 6A. The recording medium M includes a gusset unit 37 for increasing an inside volume and a reinforcing member 36 for suppressing folding, or the like.

When the recording is performed on such a recording medium M, the recording surface becomes a plane surface in a shrunk state of the recording medium M than a swollen state of the recording medium M, so that the recording can be easily performed with a high recording quality.

The recording apparatus 1 of the example is particularly effective when the recording is performed on such a recording medium M.

In the holding unit 10 of the example, as illustrated in FIG. 6B, the shape adjusting unit 33 capable of adjusting the shape of the recording medium M by sucking the air inside the recording medium M is provided. The shape adjusting unit 33 includes the cylinder unit 38 and adjusts the shape of the recording medium M by sucking the air from the inside of the pouch shape recording medium M in which the air introduces, as illustrated in FIG. 6B. Moreover, the holding unit 10 of the example includes one shape adjusting unit 33; however, it is not limited thereto, and a plurality of the shape adjusting units 33 corresponding to each set unit 31 is provided.

Accordingly, the recording apparatus 1 of the example has a configuration in which the shape is adjusted by compressing the recording medium M by decompressing the inside of the recording medium M; but for example, the shape of the recording medium M may be adjusted by compressing the recording medium M other than a method of decompressing the inside of the recording medium M. That is, the recording apparatus may have a configuration in which the shape of the recording medium M is adjusted by compressing the recording medium M. According to the above described configuration, in the recording medium M, or the like used in the examples, the shape of the recording medium M can be adjusted with high accuracy.

### Example 5

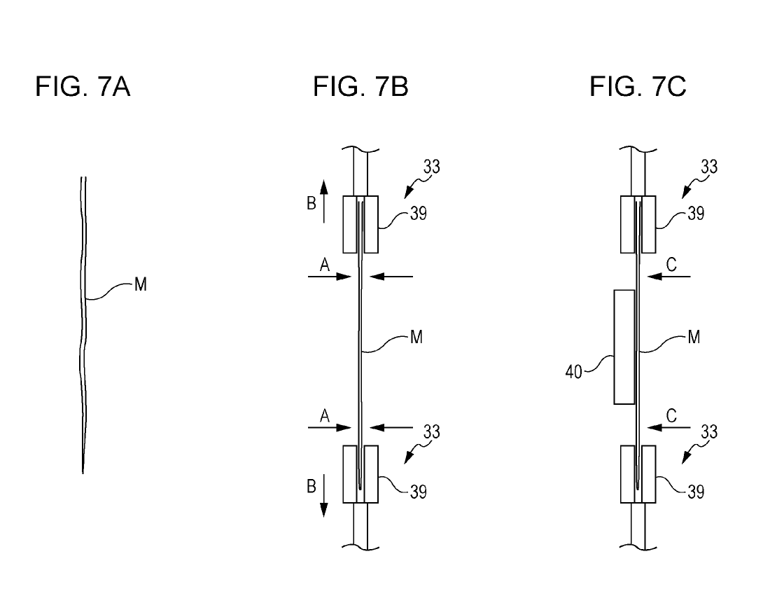

### FIGS. 7A to 7C

Next, the recording apparatus 1 of Example 5 will be described in detail with reference to the attached drawings.

FIG. 7A to FIG. 7C are schematic views illustrating the holding unit 10 which is a main part of the recording apparatus 1 of Example 5. Moreover, configuration members which are common to the above example are illustrated by the same numerals as those of the above described configuration members, and a detailed description thereof will be omitted.

Moreover, the recording apparatus 1 of the example has the same configuration as the recording apparatus 1 of Examples 1, 2, 3, and 4, except the holding unit 10.

The recording apparatus 1 of Example 3 has a configuration in which the shape of the recording medium M is adjusted by injecting the air into the inside of the recording medium M, and the recording apparatus 1 of Example 4 has a configuration in which the shape of the recording medium M is adjusted by decompressing the inside of the recording medium M. Meanwhile, the recording apparatus 1 of the example has a configuration in which the shape of the recording medium M is adjusted by giving a tension to the recording medium M.

The shape of the recording medium M varies; however, for example, as illustrated in FIG. 6A, there is a recording medium M which is easily deformed without including the reinforcing member 36. FIG. 7A is a view illustrating the recording medium M having a deformable pouch shape when viewed from a direction intersecting with the recording surface of recording medium M, and in the drawing, an upper portion thereof indicates a side capable of opening and closing in the pouch shape recording medium M.

When the recording is performed on such a recording medium M, the recording surface becomes a curved surface in a state in which the recording medium M is swollen, and it is easy for the recording surface to have a wrinkle in a state in which the recording medium M is shrunk. If a tension is applied the recording medium M, the recording surface of the recording medium M becomes a planar shape so that the recording is easily performed, and thus, a recording quality is improved.

The recording apparatus 1 of the example is particularly effective when the recording is performed on such a recording medium M.

As illustrated in FIG. 7B, the holding unit 10 of the example is provided with the shape adjusting unit 33 capable of adjusting the shape of the recording medium M by applying the tension to the recording medium M. The shape adjusting unit 33 includes the gripping unit 39. A plurality of the gripping units 39 (for example, two) grips both end parts of the recording medium M by pressurizing the recording medium M in a thickness direction A, and the tension is applied to the recording medium M by applying force in a direction B in which the recording medium M is pulled against the plurality of gripping units 39.

As described above, the recording apparatus 1 of the example has a configuration in which the shape of the recording medium M is adjusted by applying the tension to the recording medium M. With such a configuration, the shape of the recording medium M is adjusted with high accuracy.

Moreover, as a modification example of the holding unit 10 of the example, as illustrated in FIG. 7C, the planar member 40 is provided on a side opposite to the recording surface of recording medium M, and the recording medium M may be pressed against (force is applied in a C direction) the planar member 40 in a state in which the recording medium M is held by two gripping units 39. By such a configuration, the recording surface can further have a planar shape.

### Example 6

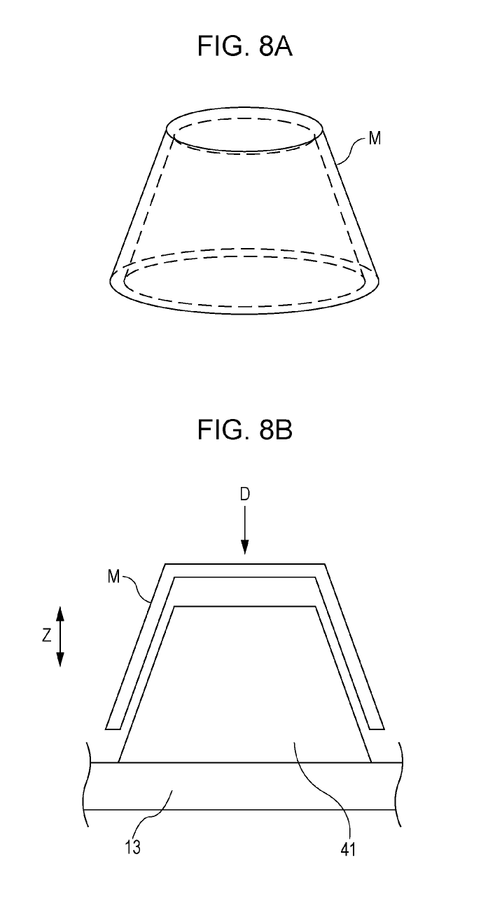

### FIGS. 8A and 8B

Next, the recording apparatus 1 of Example 6 will be described in detail with reference to the attached drawings.

FIG. 8A and FIG. 8B are schematic views illustrating the holding unit 10 which is a main part of the recording apparatus 1 of Example 6. Moreover, configuration members which are common to the above example are illustrated by the same numerals as those of the above described configuration members, and a detailed description thereof will be omitted.

Moreover, the recording apparatus 1 of the example has the same configuration as that of the recording apparatus 1 of Examples 1, 2, 3, 4, and 5, except the holding unit 10.

The shape of the recording medium M is various; however, for example, as illustrated in FIG. 8A, there is a recording medium M which has a cup shape and is easily deformed. FIG. 8A is a view illustrating the recording medium M having a cup shape in which an opening unit is positioned at the bottom thereof.

When the recording is performed on such a recording medium M, a holding unit 41 having a shape corresponding to a shape of inner part when the recording medium M has the standard shape is covered with the recording medium M so as to fit into the inside of the recording medium M. Therefore, the recording medium M is supported by the holding unit 41 and is stable and held in a state in which the recording medium has almost the standard shape, so that the recording is performed.

The recording apparatus 1 of the example includes the holding unit 41 in a shape corresponding to the shape of an inner part when the recording medium M has the standard shape. For this reason, the recording apparatus 1 of the example is particularly effective when the recording is performed on such a recording medium M.

### Example 7

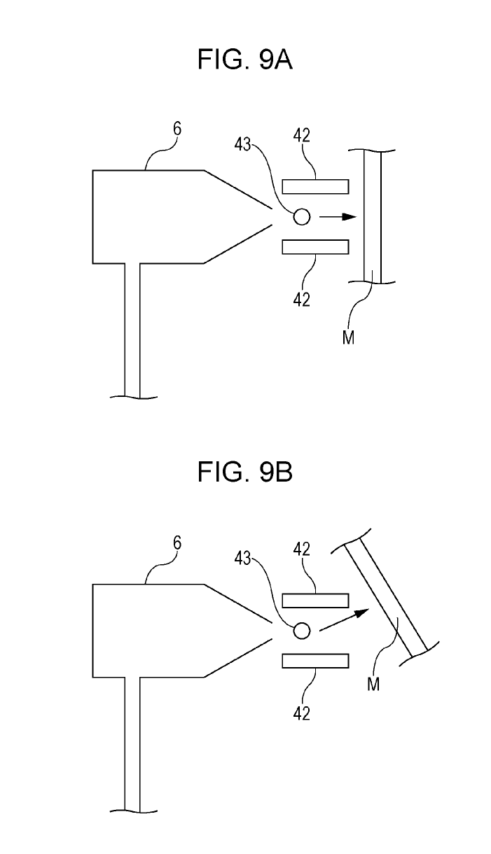

### FIGS. 9A and 9B

Next, the recording apparatus 1 of Example 7 will be described in detail with reference to the attached drawings.

FIG. 9A and FIG. 9B are schematic views illustrating a recording unit 44 which is a main part of the recording apparatus 1 of Example 7. Moreover, configuration members which are common to the above example are illustrated by the same numerals as those of the above described configuration members, and a detailed description thereof will be omitted.

Moreover, the recording apparatus 1 of the example has the same configuration as that of the recording apparatus 1 of Example 1 except that the electrode unit 42 is provided near a nozzle of the recording head 6 in the recording unit 44.

In the recording apparatus 1 of the example, ink having an electrical charge is capable of being used. For this reason, by using the ink having the electrical charge and applying voltage to the electrode unit 42, an ejecting direction of the ink ejected from the recording head 6 is capable of being changed (adjusted). Specifically, for example, as illustrated in FIG. 9A, when the recording surface of the recording medium M is in a substantially vertical state with respect to the ejecting direction of an ink droplet 43 ejected from the recording head 6, the ink droplet 43 lands on the recording surface of recording medium M as it is without applying the voltage to the electrode unit 42 so as to form a substantially complete circular shape ink dot. Meanwhile, as described in FIG. 9B, when the recording surface of the recording medium M is not in a substantially vertical state with respect to the ejecting direction of the ink droplet 43 ejected from the recording head 6, by applying the voltage to the electrode unit 42 and adjusting the ejecting direction of the ink droplets 43, the substantially complete circular shape ink dot can be formed by a substantially vertically landing the ink droplet onto the recording surface of the recording medium M. As described above, the recording can be performed by corresponding to various shape mediums.

Moreover, the recording apparatus 1 of the example has a configuration in which the ejecting direction (landing direction), of the ink can be adjusted using the ink having the electrical charge; however, the recording apparatus may have a configuration in which a charging unit charging ink without the electric charge is provided and the electric charge is applied to the ink ejected from the recording head 6.

### Example of Recording Method

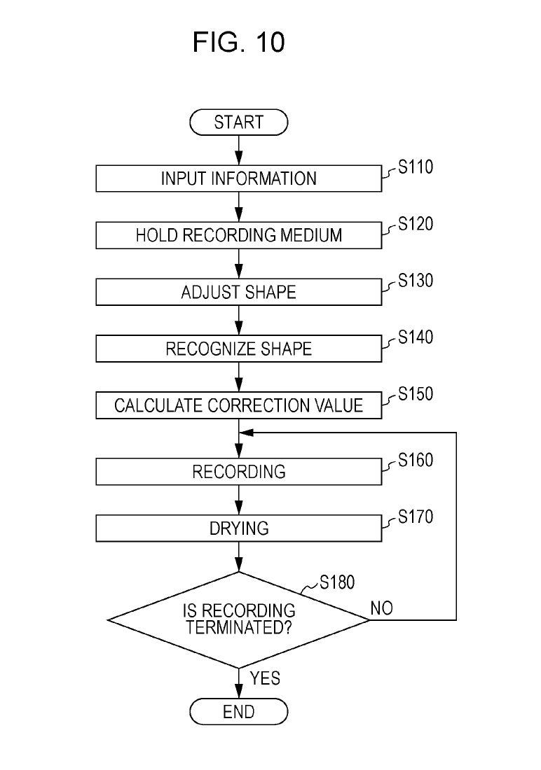

### FIG. 10

Next, an example of a recording method using the recording apparatus 1 of Example 1 will be described.

FIG. 10 is a flow chart of the recording method of the example.

At first, in an information input process in Step S110, the user inputs various information such as the standard shape of the recording medium M, the recording image information, the recording density, the recording speed, and the usable ink, using the instruction unit 21.

Next, in a recording medium holding process in Step S120, the user causes the holding unit 10 to hold the recording medium M. Specifically, the holding unit 10 holds the recording medium M by gripping the recording medium M with two gripping units 11.

Next, in a shape adjusting process in Step S130, the shape of the recording medium M is adjusted close to the standard shape using centrifugal force by rotating the gripping unit 11 in the rotation direction R3 and rotating the recording medium M with the shaft unit 14 as the rotation shaft in the rotation direction R4. Moreover, the step can be omitted. When the step is omitted, instead of a use of a shape adjusting function of the recording medium M being omitted according to the step, the omitted function is compensated for by adjusting the recording condition in a recording process in Step S160 to be performed later.

Moreover, the recording medium M is held in a state of the standard shape by the step.

Next, in a shape recognizing process in Step S140, the sensor 9 recognizes the actual shape of the recording medium M held by the holding unit 10. Moreover, the step can be omitted. When the step is omitted, instead of a use of a shape recognizing function according to the step being omitted and calculating a correction value in a correction value calculating process in next Step S150 being omitted, the omitted functions are compensated for by performing the recording in the recording process in Step S160 to be performed later based on the standard shape which is input by the user in the information input process in Step S110.

Next, in a correction value calculating process in Step S150, the control unit 18 calculates the correction value based on the standard shape input by the user in the information input process in Step S110 and the actual shape of the recording medium M recognized by the sensor 9 in the shape recognizing process in Step S140.

Moreover, in the step, the control unit 18 not only calculates the correction value, but also sets proper recording conditions (ejecting intervals of ink, liquid droplet diameter of ink, ejecting speed of ink, landing angle of ink with respect to recording medium M, posture or position of recording medium M with respect to the recording head 6, and the like).

Next, in the recording process in Step S160, the recording is performed by ejecting a desired ink from the recording head 6 based on the correction value calculated and the recording conditions set in the correction value calculating process in Step S150. Moreover, in the example, the recording is performed in order of a base layer, an image forming layer, and an overcoat layer; however, at least one of the base layer and the overcoat layer may be omitted.

In addition, after the recording process in Step S160 or at the same time of the recording process in Step S160, in a drying process in Step S170, the heater 19 dries the ink ejected to the recording medium M. Moreover, the step can be omitted. When the step is omitted, a use of the drying process according to Step S170 is omitted, the omitted function is compensated for by adjusting the recording condition set by the control unit 18, for example, by controlling the recording to be performed in the recording mode in which the diameter of the ink droplet ejected from the recording head 6 is small, or controlling the recording to be performed in the recording mode in which the recording speed is slow so as to make it easy to naturally dry the ink.

In addition, in a recording terminating determination process in Step S180, a procedure returns to the recording process in Step S160 when determining that the recording is not terminated by determining whether or not the recording is terminated based on recording data, but the recording method of the example is terminated when determining that the recording is terminated.

According to the recording method of the example, the recording is performed by stabilizing the shape of the recording medium M and holding the shape, such that a deterioration of the recording image quality when the shape of the recording medium M is not stabled can be suppressed.

Moreover, the invention is not limited to above described examples. The invention can be variously modified within a range of the invention disclosed in Claims, and it is apparent that the modifications thereof are also included in the range of the invention.

Hereinabove, the detailed description of the invention is described based on the specific examples. Here, the invention will be summarized and described again.

The recording apparatus 1 of a first aspect of the invention includes the input unit 20 that inputs the standard shape of the medium M, the shape recognizing unit 9 that recognizes the actual shape of the medium M, the calculating unit 18 that calculates the correction value based on the standard shape and the actual shape, and the recording unit 44 that includes the ejecting unit 6 which ejects liquid to the medium M, in which recording conditions are adjusted based on the correction value.

Here, the “standard shape” means a shape of the medium M which is assumed when the recording apparatus 1 performs the recording on the medium M, but it is not particularly limited thereto.

According to a first aspect, the correction value is calculated based on the standard shape and the actual shape, and the recording condition is adjusted based on the correction value. For this reason, the correction value can be calculated corresponding to various mediums by assuming the various standard shapes, and the recording condition is adjusted based on the calculated correction value so that the recording can be performed corresponding to the mediums having various shapes.

In the recording apparatus 1 of a second aspect of the invention, according to the first aspect, the shape recognizing unit 9 recognizes the actual shape of the medium when the liquid is ejected to the medium M.

According to the aspect, the shape recognizing unit recognizes the actual shape of the medium M when the liquid is ejected to the medium M. That is, since the correction value is calculated based on the shape of the medium M when the recording is performed, the recording corresponding to the various shapes of the medium can be performed with high accuracy.

In the recording apparatus 1 of a third aspect of the invention, according to the first aspect or second aspect, an adjustment of the recording conditions is an adjustment of at least one of ejecting intervals of the liquid, a diameter of liquid droplet of the liquid, an ejecting speed of the liquid, and a landing angle of the liquid with respect to the recording medium M.

According to the aspect, by adjusting at least one of the ejecting intervals of the liquid, the diameter of liquid droplet of the liquid, the ejecting speed of the liquid, and the landing angle of the liquid with respect to the medium M, that is, the ejecting conditions (controlling liquid droplet), the recording corresponding to the various shapes of the medium can be performed.

In the recording apparatus 1 of a fourth aspect of the invention, according to any one of the first aspect to the third aspect, a holding unit 10 that holds the medium M is further included, in which the holding unit 10 holds the medium in such a manner that at least one of a posture and a position of the medium M with respect to the ejecting unit 6 can be changed, and the adjustment of the recording conditions is an adjustment of at least one of the posture and the position of the medium M with respect to the ejecting unit 6 in the holding unit 10.

According to the aspect, the recording corresponding to the various shapes of the medium can be performed by adjusting at least one of the posture and the position of the medium M with respect to the ejecting unit 6 in the holding unit 10, that is, by adjusting a holding condition of the medium M.

In the recording apparatus 1 of a fifth aspect of the invention, according to the first aspect to the fourth aspect, the holding unit 10 that holds the medium M is included, in which the recording unit 44 includes an ejecting unit moving mechanism 28 which is capable of changing at least one of the posture and the position of the ejecting unit 6 with respect to the holding unit 10, and the adjustment of the recording conditions is an adjustment of at least one of the posture and the position of the ejecting unit 6 with respect to the holding unit 10 in the ejecting unit moving mechanism 28.

According to the aspect, the recording corresponding to the various shapes of the medium can be performed by adjusting at least one of the posture and the position of the ejecting unit 6 with respect to the holding unit 10, that is, by adjusting the position of the ejecting unit 6 with respect to the medium M.

In the recording apparatus 1 of a sixth aspect of the invention, according to any one of the first aspect to the fifth aspect, the liquid ejected from the ejecting unit 6 has a electric charge, the recording unit 44 includes an electrode unit 42 which is capable of changing an ejecting direction of the liquid having the electric charge, and the adjustment of the recording conditions is an adjustment of the ejecting direction of the liquid by the electrode unit 42.

According to the aspect, the recording corresponding to the various shapes of the medium can be performed by adjusting the ejecting direction of the liquid by the electrode unit 42.

In the recording apparatus 1 of a seventh aspect of the invention, according to any one of the first aspect to the sixth aspect, the medium M has a stereoscopic shape.

Performing the recording corresponding to the stereoscopic shape medium is more difficult than performing recording corresponding to a sheet type medium M; however, according to the aspect, even in when the medium M is in the stereoscopic shape, the recording corresponding to the shape can be performed.

The entire disclosure of Japanese Patent Application No. 2014-142943, filed Jul. 11, 2014 is expressly incorporated by reference herein.

What is claimed is:

1. A recording apparatus comprising:
an input unit that inputs a standard shape of a medium;
a shape recognizing unit that recognizes an actual shape of the medium;
a calculating unit that calculates a correction value based on the standard shape and the actual shape; and
a recording unit that includes an ejecting unit which ejects liquid to the medium,
wherein recording conditions are adjusted based on the correction value.

2. The recording apparatus according to claim 1,
wherein the shape recognizing unit recognizes the actual shape of the medium when the liquid is ejected to the medium.

3. The recording apparatus according to claim 1,
wherein an adjustment of the recording conditions is an adjustment of at least one of ejecting intervals of the liquid, a diameter of liquid droplet of the liquid, an ejecting speed of the liquid, and a landing angle of the liquid with respect to the medium.

4. The recording apparatus according to claim 1, further comprising:
a holding unit that holds the medium,
wherein the holding unit holds the medium in such a manner that at least one of a posture and a position of the medium can be changed with respect to the ejecting unit, and
wherein the adjustment of the recording conditions is an adjustment of at least one of the posture and the position of the medium with respect to the ejecting unit in the holding unit.

5. The recording apparatus according to claim 1, comprising:
a holding unit that holds the medium,
wherein the recording unit includes an ejecting unit moving mechanism which is capable of changing at least one of the posture and the position of the ejecting unit with respect to the holding unit,
wherein the adjustment of the recording conditions is an adjustment of at least one of the posture and the position of the ejecting unit with respect to the holding unit in the ejecting unit moving mechanism.

6. The recording apparatus according to claim 1,
wherein the liquid ejected from the ejecting unit has an electric charge,
wherein the recording unit includes an electrode unit which is capable of changing an ejecting direction of the liquid having the electric charge, and
wherein the adjustment of the recording conditions is an adjustment of the ejecting direction of the liquid by the electrode unit.

7. The recording apparatus according to claim 1,
wherein the medium has a stereoscopic shape.
